(19) United States
(12) Patent Application Publication
(10) Pub. No.: US 2008/0186349 A1
(43) Pub. Date: Aug. 7, 2008

(54) INKJET PRINTER HAVING WIDE ARRAY HEAD AND IMAGE FORMING METHOD THEREFOR

(75) Inventor: Si-joong JANG, Suwon-si (KR)

Correspondence Address: STEIN, MCEWEN & BUI, LLP, 1400 EYE STREET, NW, SUITE 300, WASHINGTON, DC, 20005, US

(73) Assignee: Samsung Electronics Co., Ltd., Suwon-si (KR)

(21) Appl. No.: 11/850,957

(22) Filed: Sep. 6, 2007

(30) Foreign Application Priority Data
Feb. 6, 2007 (KR) 2007-12353

(51) Int. Cl. B41J 29/38

(52) U.S. Cl. 347/16

(57) ABSTRACT

An inkjet printer having a wide array head and an image forming method for use in the inkjet printer having the wide array head includes a nozzle group setting unit for grouping nozzles of the wide array head into N (N is an integer larger than 1) groups and grouping the N groups into K groups (K is an integer between 1 and N); a printing media sensing unit determining whether a rear edge of a current printing medium passes the nozzles of one of the K groups; and a printing media convey controller conveying a front edge of a next printing medium to the nozzles of the group K if the rear edge of the current printing medium passes the nozzles of the one of the K groups. Therefore, the nozzles of the wide array head are classified into groups, and the beginning and completion of the printing operation can be identified by the nozzle group unit, and thus, the printing can be performed at high speed.

### CROSS-REFERENCE TO RELATED APPLICATION

This application claims the benefit of Korean Patent Application No. 2007-0012353, filed on Feb. 6, 2007, in the Korean Intellectual Property Office, the disclosure of which is incorporated herein by reference.

### BACKGROUND OF THE INVENTION

1. Field of the Invention

An aspect of the present invention relates to a printer having a wide array head that is formed by connecting inkjet print heads in an array, and more particularly, to an inkjet printer having a wide array head that can minimize a conveying period between sheets in a printing operation and an image forming method for the inkjet printer having the wide array head.

2. Description of the Related Art

Wide array head type inkjet printers that perform a printing operation on the entire surface of printing media include software and hardware (S/W and H/W) for printing images in a computer or other imaging apparatuses, a printer controller forming and transferring printing data from original data, a wide array head receiving the printing data from the printer controller and ejecting ink onto a printing medium, and a conveying device picking and conveying the printing medium. Conventionally, the wide array head type inkjet printer operates as follows. First, when a printing command is received, the inkjet printer forms a printing image. The generated printing image is converted into printing data that is to be transferred to the wide array head by the printer controller. When the printing data is ready to be printed, the conveying device picks up a printing medium. The printing medium is conveyed to the wide array head by the conveying device. The wide array head ejects ink in synchronization with the conveying device to perform the printing operation. After the printing operation for one sheet is completed, a maintenance operation is performed.

Completion of printing for one page is determined by establishing whether the printing medium has passed through the last nozzle of the head including a plurality of arrays. When the next page enters the wide array head or if determined to be necessary, the maintenance operation is performed.

FIG. 1 is a diagram illustrating an image forming process performed in the inkjet printer including the conventional wide array head. Referring to FIG.1, the next printing medium generally enters the wide array head after the current printing medium has completely passed through the wide array head. Therefore, a distance d2 between the printing media must be larger than a distance d1 that is a width of the wide array head. Therefore, the distance between the printing media cannot be reduced less than d1 when high speed printing is performed. Since the distance between the printing media cannot be reduced, printing at an even higher speed cannot be performed.

### SUMMARY OF THE INVENTION

An aspect of the present invention provides an inkjet printer having a wide array head so that a high speed printing operation can be performed when printing onto a plurality of printing media by reducing a distance between the printing media, and an image forming method for use in the inkjet printer having the wide array head.

According to an aspect of the present invention, there is provided an inkjet printer having a wide array head, the inkjet printer including: a nozzle group setting unit for grouping nozzles of the wide array head into N (N is an integer greater than 1) groups and grouping K groups among the N groups, wherein K is a positive integer less than N and if K is more than 1, than 1, then all subgroups in K are adjacent; a printing media sensing unit determining whether a rear edge of a current printing medium passes the nozzles of the K group; and a printing media convey controller conveying a front edge of a next printing medium to the nozzles of the K group if the rear edge of the current printing medium passes the nozzles of the K group.

According to another aspect of the present invention, there is provided an image forming method for use in an inkjet printer having a wide array head, the method including: grouping nozzles in the wide array head into one to N groups (N is an integer greater than 1) and grouping K groups among the N groups, wherein K is a positive integer less than N and if K is more than 1, then all subgroups in K are adjacent; determining whether a rear edge of a current printing medium passes the nozzles of the K group; conveying a front edge of a next printing medium to the nozzles of the K group if the rear edge of the current printing medium passes the nozzles of the K group.

Additional aspects and/or advantages of the invention will be set forth in part in the description which follows and, in part, will be obvious from the description, or may be learned by practice of the invention.

### BRIEF DESCRIPTION OF THE DRAWINGS

These and/or other aspects and advantages of the invention will become apparent and more readily appreciated from the following description of the embodiments, taken in conjunction with the accompanying drawings of which:

FIG. 1 is a diagram illustrating an image forming process performed in a printer having a wide array head according to the conventional art;

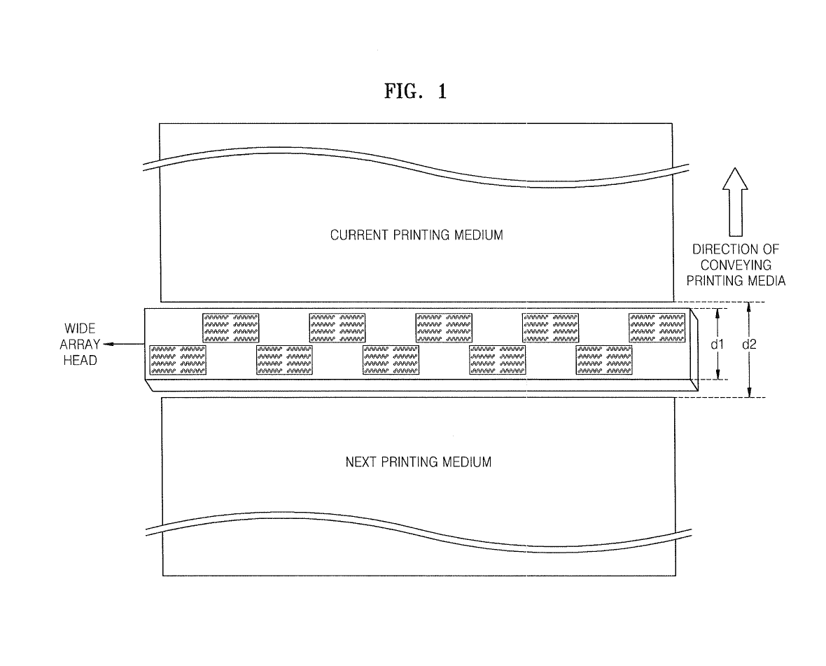

FIG. 2 is a block diagram of an inkjet printer having a wide array head according to an embodiment of the present invention;

FIG. 3 is a diagram of the wide array head of FIG. 2, in which nozzles are grouped according to the type of wide array head;

FIG. 4 is a side view illustrating a printing medium passing through groups of nozzles of the wide array head of FIG. 2, according to an embodiment of the present invention;

FIG. 5 is a view illustrating a distance between printing media when the printing media are conveyed, according to an embodiment of the present invention; and

FIG. 6 is a flowchart illustrating an image forming method performed in the inkjet printer of FIG. 2, according to another embodiment of the present invention.

### DETAILED DESCRIPTION OF THE EMBODIMENTS

Reference will now be made in detail to the present embodiments of the present invention, examples of which are illustrated in the accompanying drawings, wherein like reference numerals refer to the like elements throughout. The embodiments are described below in order to explain the present invention by referring to the figures.

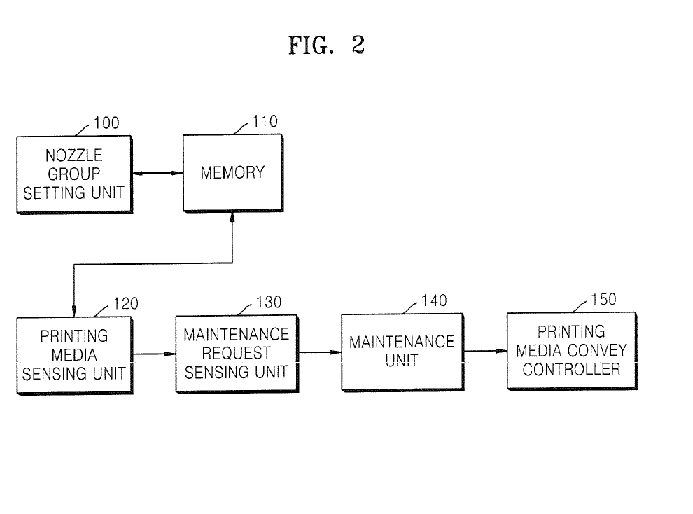

FIG. 2 is a block diagram of an inkjet printer having a wide array head according to an embodiment of the present invention. The inkjet printer includes a nozzle group setting unit 100, a memory 110, a printing media sensing unit 120, a maintenance request sensing unit 130, a maintenance unit 140, and a printing media convey controller 150.

The nozzle group setting unit 100 divides nozzles of the wide array head into one to N (N is an integer greater than 1) groups.

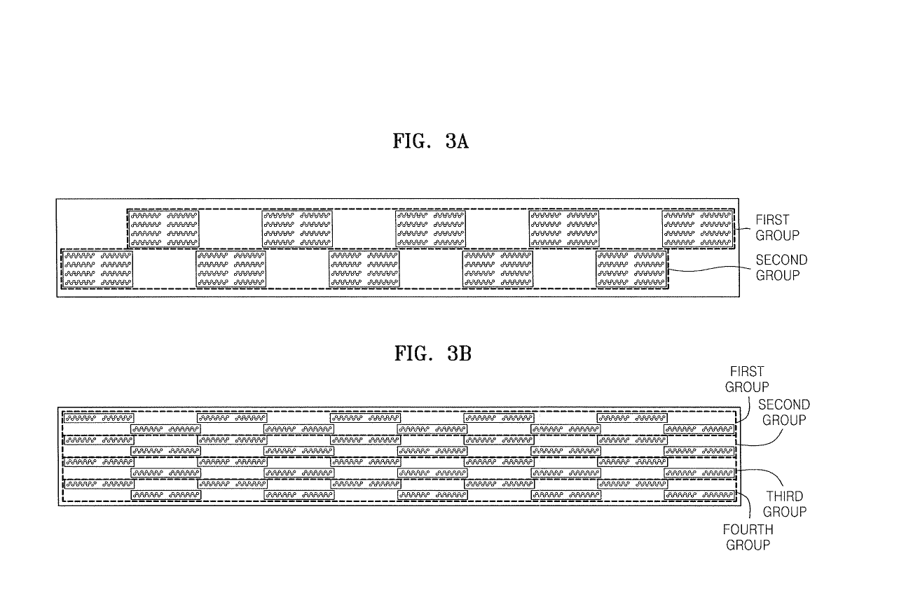

FIGS. 3A and 3B are diagrams showing an example of grouping the nozzles according to the type of wide array head. FIG. 3A shows the wide array head including unit heads, each head including nozzles ejecting inks of cyan, magenta, yellow, and black colors, and the heads are grouped into a first group and a second group. FIG. 3B illustrates each of the nozzles ejecting the cyan, magenta, yellow, and black inks forming an independent head, and the heads classified into first through fourth groups form the wide array head. Referring to FIGS. 3A and 3B, the nozzles can be grouped in various ways according to the type of wide array head. The nozzle group setting unit 100 has a user interface so that a manufacturer of the printer or a user of the printer can set the grouping reference of the nozzles. That is, the user interface screen is provided so that the manufacturer or the user of the printer can set the grouping of the nozzles, and the nozzles of the wide array head are classified into groups according to grouping information input by the user. The grouping information is output to the memory 110.

The memory 110 receives the grouping information set by the nozzle group setting unit 100 and stores the input information. In addition, the memory 110 stores information about positions of the unit head forming the wide array head, and information about distances between nozzles. The position information of the unit heads represents the position where the corresponding head is located in the wide array head.

The printing media sensing unit 120 determines whether a rear edge of the printing medium passes through the nozzles of a K group (K is an integer between 1 and N), and outputs the determination result to the maintenance request sensing unit 130. The printing media sensing unit 120 is provided with the information of the nozzle groups, the position information of the nozzle groups, and the information about the distance between nozzles stored in the memory 110. The printing media sensing unit 120 determines whether the rear edge of the current printing medium passes through the nozzles of the K group using the received information about the groups of nozzles, position information of the nozzles, and the information about the distances between the nozzles. To do this, the printing media sensing unit 120 includes a printing media sensor.

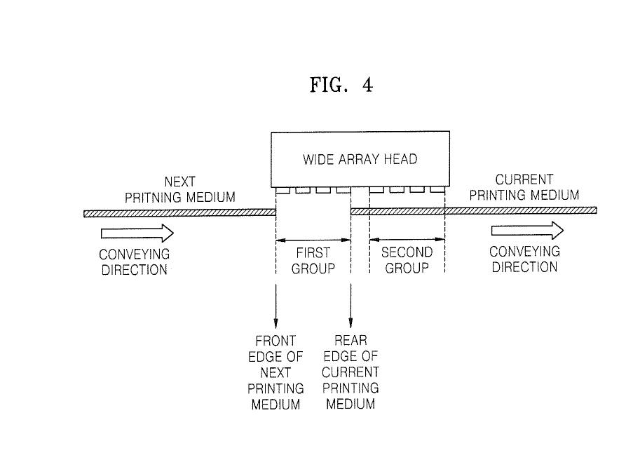

FIG. 4 is a side view illustrating a process in which the printing medium passes through the groups of nozzles. For example, it is assumed that the nozzles are divided into the first and second groups as shown in FIG. 3A according to the setting information of the nozzle group setting unit 100, and group K is the first group. Then, the printing media sensing unit 120 determines whether the rear edge of the current printing medium passes through the first group of the wide array head in FIG. 4. Since the printing media sensing unit 120 is aware of the position information of the nozzles and the distance between the nozzles of the first group, the printing media sensing unit 120 can determine whether the rear edge of the current printing medium has passed completely through the first group by counting the conveying speed of the printing medium. The rear edge of the current printing medium after passing the first group enters the second group. If the rear edge of the current printing medium is completely output from the first group, the first group is ready to receive the next printing medium.

When the rear edge of the current printing medium passes the nozzles of group K, the maintenance request sensing unit 130 determines whether the maintenance operation of the nozzles in the group K is required or not. For example, as shown in FIG. 4, if the rear edge of the current printing medium has completely passed the first group, the maintenance request sensing unit 130 determines whether the maintenance operation of the nozzles in the first group will be performed or not. The maintenance request sensing unit 130 compares the number of dots ejected from the nozzles of the first group with a threshold value to determine whether the maintenance operation is required. For example, if the number of dots is equal to the threshold value or smaller, it can be determined that the maintenance operation is required. The determination result that the maintenance is required is output to the maintenance unit 140, and the determination result that the maintenance is not required is output to the printing media convey controller 150.

When the maintenance unit 140 receives the determination result for performing the maintenance from the maintenance request sensing unit 130, the maintenance unit 140 performs the predetermined maintenance operation of the nozzles of the group K, and outputs the maintenance result to the printing media convey controller 150. The maintenance unit 140 performs a jetting operation and a wiping operation as the maintenance operation. In the jetting operation, the inks are integrally jetted in order to prevent an image quality from being degraded when the number of dots ejected from the nozzles of the group K is smaller than the threshold value, and in the wiping operation, surfaces of the nozzles are cleaned.

If the printing media convey controller 150 receives the determination result that the maintenance is not required from the maintenance request sensing unit 130 or the maintenance result from the maintenance unit 140, the printing media convey controller 150 moves a front edge of the next printing medium to the nozzles of the group K. When the maintenance operation is not required after the rear edge of the current printing medium has completely passed the first group, or when the maintenance operation is completed, the printing media convey controller 150 controls the conveying of the printing media so that the front edge of the next printing medium can enter the first group.

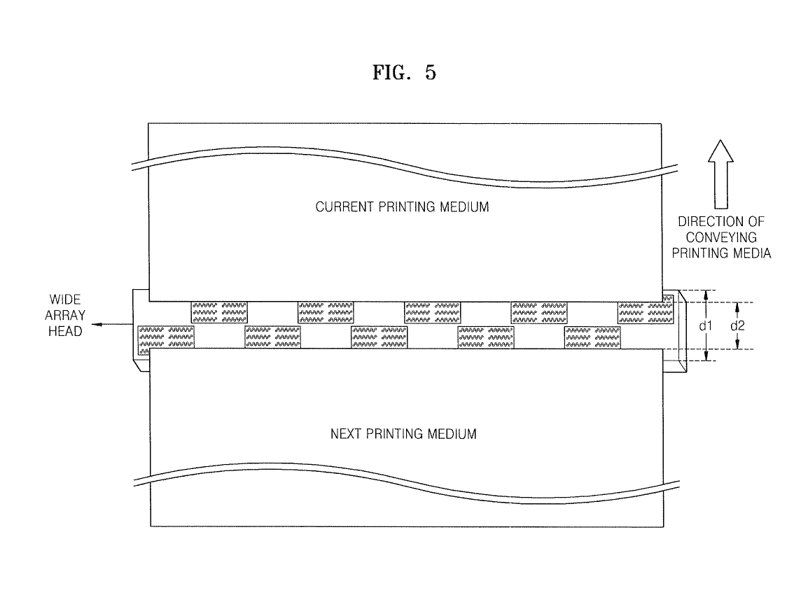

FIG. 5 is a diagram illustrating a distance between the printing media when the printing media are conveyed according to the current embodiment. As shown in FIG. 5, the nozzles of the wide array head are divided into the first group and the second group, and the conveying of the printing media is controlled by the nozzle group unit, and thus, a distance d2 between the printing media can be reduced to be smaller than d1, that is, the width of the wide array head. Therefore, the image forming operation can be performed at high speed.

Hereinafter, an image forming method for use in the inkjet printer having the wide array head according to an embodiment of the present invention will be described with reference to accompanying drawings.

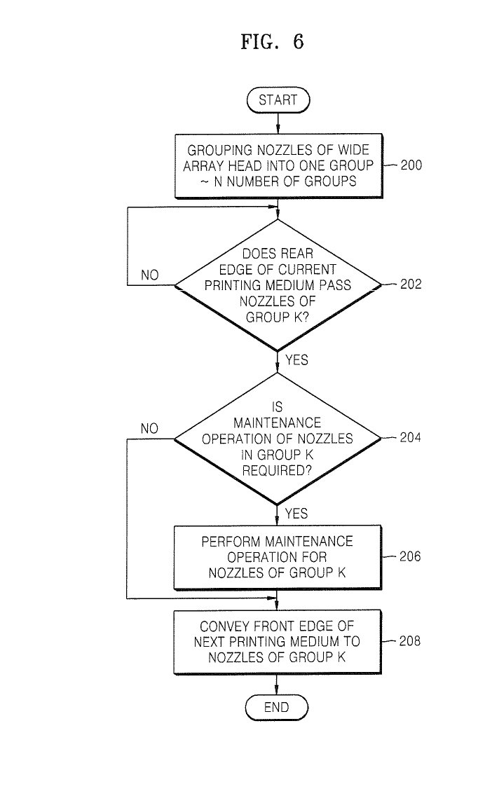

FIG. 6 is a flowchart illustrating the image forming method for use in the inkjet printer having the wide array head according to an embodiment of the present invention.

The nozzles of the wide array head are divided into one to N (N is an integer greater than 1) groups (S200). Using the user interface screen, the nozzles of the wide array head are classified into a few groups according to the information input by the user.

Then, it is determined whether the rear edge of the current printing medium passes the nozzles of the group K (K is an integer between 1 and N) (S202). This determination can be performed using the information of the nozzles of the groups, the position information of the grouped nozzles, and/or the information about the distance between nozzles. Thus, it is determined that the rear edge of the current printing medium passes the first group in the wide array head as shown in FIG. 4. Since the position information of the nozzles in the first group and the distance between the nozzles are provided, whether the rear edge of the current printing medium has completely passed the first group can be determined by measuring the speed of conveying the printing medium. The position information of the nozzles and the distance between the nozzles in the wide array head are stored in the memory.

If the rear edge of the current printing medium does not pass the nozzles of the group K, process S202 is repeatedly performed.

However, if the rear edge of the current printing medium passes the nozzles of the group K, it is determined whether the maintenance operation of the nozzles in the group K is required (S204). For example, as shown in FIG. 4, if the rear edge of the current printing medium has completely passed the first group, it is determined whether the maintenance operation of the nozzles in the first group is required or not. In particular, the number of dots ejected from the nozzles of the first group is compared with the threshold value to determine whether the maintenance operation will be performed or not.

If the maintenance operation is not required, a process S208 that will be described later is performed.

However, if the maintenance operation is required, the predetermined maintenance operation of the nozzles in the group K is performed (S206). For example, if the number of dots is equal to the threshold value or smaller, it can be determined that the maintenance operation is required. The jetting operation and the wiping operation are performed as the maintenance operation.

After the process S206 or S204, the front edge of the next printing medium is moved to the nozzles of the group K (S208). For example, after the rear edge of the current printing medium has completely passed the first group, if the maintenance operation is not required or the maintenance operation is completed, the printing medium is conveyed so that the front edge of the next printing medium can enter the first group of nozzles.

Meanwhile, the method of an aspect of the present invention can be achieved in the form of codes/instructions/software program, which can be performed in a computer, and can be realized in a general-purpose digital computer, which operates the codes/instructions/program using a recording medium readable by the computer. That is, a computer-readable recording medium includes the software program for performing the processes of grouping the nozzles of the wide array head into one through N (N is an integer greater than 1) groups, determining whether the rear edge of the current printing medium passes the nozzles in the group K (K is an integer between 1 and N), and conveying the front edge of the next printing medium to the nozzles of the group K if the rear edge of the current printing medium passes the nozzles of the group K.

The computer-readable recording medium includes a storage medium such as a magnetic storing medium (for example, a ROM, a floppy disk, and a hard disk), an optical read-out medium (for example, a CD-ROM, DVD), and a computer data signal embodied in a carrier wave comprising a compression source code segment and an encryption source code segment (such as data transmission through the Internet). In addition, the embodiments of the present invention can be realized as media including computer readable codes, and thus, a plurality of computer systems connected to each other by a network can separately process. The programs, codes, and code segments realizing the embodiments of the present invention can be construed easily by programmers in the art.

According to the inkjet printer having the wide array head and the image forming method for use in the inkjet printer having the wide array head of an aspect of the present invention, the beginning and the completion of the printing operation performed by the nozzles that are classified into groups are respectively identified by the group unit to perform the next process, the distance between the printing media can be reduced, and the image can be printed onto the plurality of printing media with the high speed.

Although a few embodiments of the present invention have been shown and described, it would be appreciated by those skilled in the art that changes may be made in this embodiment without departing from the principles and spirit of the invention, the scope of which is defined in the claims and their equivalents.

What is claimed is:

1. An inkjet printer having a wide array head, the inkjet printer comprising:
a nozzle group setting unit for grouping nozzles of the wide array head into one to N (N is an integer larger than 1) groups;
a printing media sensing unit determining whether a rear edge of a current printing medium passes the nozzles in a group K (K is an integer between 1 and N); and
a printing media convey controller moving a front edge of a next printing medium to the nozzles of the group K if the rear edge of the current printing medium passes the nozzles of the group K.

2. The inkjet printer of claim 1, wherein the printing media sensing unit determines whether the rear edge of the current printing medium passes the nozzles of the group K using information about positions of the nozzles in the wide array head and information about distances between the nozzles.

3. The inkjet printer of claim 2, further comprising:
a memory storing the position information and the distance information of the nozzles in the wide array head.

4. The inkjet printer of claim 1, further comprising:
a maintenance request sensing unit determining whether a maintenance operation of the nozzles in the group K is required when the rear edge of the current printing medium passes the nozzles in the group K; and
a maintenance unit performing a predetermined maintenance operation of the nozzles in the group K when it is determined that the maintenance operation is required,
wherein the printing media convey controller conveys the front edge of the next printing medium to the nozzles of the group K after performing the predetermined maintenance operation.

5. The inkjet printer of claim 4, wherein the maintenance request sensing unit compares the number of dots ejected from the nozzles of the group K with a threshold value to determine whether the maintenance operation is required.

6. The inkjet printer of claim 4, wherein the maintenance unit performs a spitting operation and a wiping operation.

7. An image forming method for use in an inkjet printer having a wide array head, the method comprising:
grouping nozzles in the wide array head into one to N groups (N is an integer larger than 1);
determining whether a rear edge of a current printing medium passes the nozzles in a group K (K is an integer between 1 and N);
conveying a front edge of a next printing medium to the nozzles of the group K if the rear edge of the current printing medium passes the nozzles of the group K.

8. The method of claim 7, wherein whether the rear edge of the current printing medium passes the nozzles of the group K is determined using information about positions of the nozzles in the wide array head and information about distances between the nozzles.

9. The method of claim 8, wherein the position information and the distance information of the nozzles in the wide array head are stored in a memory.

10. The method of claim 7, further comprising:
determining whether a maintenance operation of the nozzles in the group K is required when the rear edge of the current printing medium passes the nozzles of the group K;
performing a predetermined maintenance operation of the nozzles in the group K if it is determined that the maintenance operation is required;
conveying a front edge of a next printing medium to the nozzles of the group K after performing the maintenance operation.

11. The method of claim 10, wherein the determining of the maintenance operation is performed by comparing the number of dots ejected from the nozzles of the group K with a threshold value.

12. The method of claim 10, wherein the predetermined maintenance operation includes a spitting operation and a wiping operation.

13. A computer readable recording medium having embodied thereon a computer program for executing an image forming method comprising:
grouping nozzles in a wide array head into one to N groups (N is an integer larger than 1);
determining whether a rear edge of a current printing medium passes the nozzles in a group K (K is an integer between 1 and N);
conveying a front edge of a next printing medium to the nozzles of the group K if the rear edge of the current printing medium passes the nozzles of the group K.

14. An inkjet printer having a wide array head including a plurality of nozzles, the inkjet printer comprising:
a nozzle group setting unit for grouping the plurality of nozzles of the wide array head into groups;
a printing media sensing unit determining whether a rear edge of a current printing medium passes the nozzles of a first group; and
a printing media convey controller conveying a front edge of a next printing medium to the nozzles of the first group if the rear edge of the current printing medium passes the nozzles of the first group.

15. The inkjet printer of claim 14, wherein the printing media sensing unit determines whether the rear edge of the current printing medium passes the nozzles of the first group using information about positions of the nozzles in the wide array head and information about distances between the nozzles.

16. The inkjet printer of claim 15, further comprising:
a memory storing the position information and the distance information of the nozzles in the wide array head.

17. The inkjet printer of claim 14, further comprising:
a maintenance request sensing unit determining whether a maintenance operation of the nozzles of the first group is required when the rear edge of the current printing medium passes the nozzles of the first group; and
a maintenance unit performing a predetermined maintenance operation of the nozzles of the first group when determined that the maintenance operation is required,
wherein the printing media convey controller conveys the front edge of the next printing medium to the nozzles of the first group after performing the predetermined maintenance operation.

18. The inkjet printer of claim 17, wherein the maintenance request sensing unit compares the number of dots ejected from the nozzles of the first group with a threshold value to determine whether the maintenance operation is required.

19. The inkjet printer of claim 17, wherein the maintenance unit performs a jetting operation and a wiping operation.

20. The inkjet printer of claim 14, wherein a distance between the current printing medium and the next printing medium is smaller than a width of the wide array head.
